(19) United States
(12) Patent Application Publication
(10) Pub. No.: US 2007/0165512 A1
(43) Pub. Date: Jul. 19, 2007

(54) Information Processing Apparatus

(75) Inventors: Takeshi HARADA, Tokyo (JP); Mieko ISHII, Tokyo (JP); Yasushi GOTO, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI LTD., Tokyo (JP)

(21) Appl. No.: 11/616,449

(22) Filed: Dec. 27, 2006

(30) Foreign Application Priority Data
Dec. 27, 2005 (JP) JP2005-373921

(51) Int. Cl. G11B 9/00

(52) U.S. Cl. 369/126

(57) ABSTRACT

For information recording, a structure for supporting a medium component or a probe-installed cantilever array component while regulating relative positions thereof is provided. A moving component includes a plurality of first electrodes or magnetic poles arranged at three or more spots thereof, and disposed between two fixed components. The two fixed components include a plurality of second electrodes or magnetic poles configured to repel or attract the plurality of first electrode or magnetic poles. The plurality of second electrodes or magnetic poles are significantly different in size in a plane parallel to the X-Y plane from the plurality of first electrodes or magnetic poles. In one embodiment, the moving component may be supported by servo control.

### CROSS-REFERENCE TO RELATED APPLICATION(S)

This application claims the foreign priority benefit under Title 35, United States Code, § 119 (a)-(d), of Japanese Patent Application No. 2005-373921, filed on Dec. 27, 2005 in the Japan Patent Office, the disclosure of which is herein incorporated by reference in its entirety.

### BACKGROUND OF THE INVENTION

This invention relates to information processing apparatuses, and more particularly to a microminiaturized storage device for information recording, which is capable of recording an enormous volume of electronic data (as information) at high speed and at an extremely high density.

The information processing system using a computer as a key device have rapidly become pervasive in various fields of application, ranging from systems for information communications network, as typified by the Internet and local area networks or LANs, to those for use in household appliances and automobiles, which have become prevailing recently. Most of such systems need to have storage devices for storing electronic information temporarily or semipermanently therein. Thus, as the volume of electronic information to be handled in the systems increases, microminiaturized, fast and high-capacity storage devices are in increasing demand year by year.

Conventional information storage technologies have provided two dominant recording schemes: magnetic recording and optical recording; it has however been shown that the both schemes are approaching their limits of capacity. That is, the magnetic recording has its capacity limit imposed by the volume limit of magnetic material required for magnetization reversal mechanism using magnetic field, and the optical recording has its capacity limit imposed by the diffraction limit of light. Thus, the recording density cannot be increased beyond its intrinsic capacity limit for either scheme. Particularly, for the magnetic recording, the increase in areal or surface recording density, which has set records yearly up by one hundred percent since the giant magnetoresistive (GMR) head technology was brought into practical use, appears to suffer an inevitable slowdown.

Probe storage technology is a storage technology proposing an alternative recording scheme which is expected to overstep the limits imposed in the aforementioned conventional schemes. The probe storage technology proposes several methods, which include: a method of applying the principle of a scanning probe microscope (hereinafter referred to as “SPM”) to near-field scanning of an object through a microminiature probe tip for detecting a physical quantity with a spatial resolution at an atomic or molecular level; a method of utilizing the quantum effect of substances from an ultimate single atom that is used as an information recording unit; and a microminiature mechanical recording method utilizing a probe structure.

The method of applying the principle of SPM has been proposed for example in U.S. Pat. No. 5,808,977, which discloses a method of recording and detecting a magnetic domain structure through a probe tip on the principle of the magnetic force microscope (hereinafter referred to as “MFM”). This method is one prospective recording method for achieving high-density recording, by detecting displacements of a probe tip, which is caused by a magnetic force the probe tip made of magnetic material receives when the probe tip is moved across a magnetic domain recorded on a magnetic recording medium.

The mechanical recording method utilizing a probe structure has been proposed for example in Vettiger, P.; Cross, G.; Despont, M.; Drechsler, U.; Durig, U.; Gotsmann, B.; Haberle, W.; Lantz, M. A.; Rothuizen, H. E.; Stutz, R.; Binnig, G. K., ‘The “millipede”—nanotechnology entering data storage’, IEEE Transactions on Nanotechnology Vol. 1, Issue 1, March 2002, pp 39-55 or U.S. Pat. No. 5,835,477, which discloses a method of recording information by pressing a probe tip heated to and maintained constant at a specific temperature, onto a recording medium made of resinous material to form minute pits. This method provides a cantilever array component in which a number of cantilevers each having a probe element (probe tip) disposed at its tip are arranged in such a manner that a plurality of probe tips are opposed to a medium, so that each one of the probe tips is configured to record information onto one specific area (pixel) corresponding thereto of the medium independently and thus the plurality of probe tips can record pixels in parallel. The cantilever array component as used in this method has a substantially complete set of specific components of a storage device, and is expected to achieve improved data transfer rate due to its parallel processing capability and improved recording density due to its miniaturized probe structure.

Another example of the mechanical recording method utilizing a probe structure is proposed for example in JP 10-40597 A, which discloses a memory device including a cantilever array component, a recording medium component and an actuator, which are each laminated on a substrate and joined together in layers, wherein the distance between a probe and a medium are regulated by a suction electrode.

In the conventional technology as disclosed in U.S. Pat. No. 5,808,977, there remain several technical challenges to be addressed, for example, in a magnetic field generation mechanism for applying a magnetic field strong enough to write information on a magnetic recording medium through the probe tip made of magnetic material, an actuator for keeping a small gap between the probe tip and the magnetic recording medium at a certain distance, and a contrivance for increasing a data transfer rate in an information reading/writing operation. Therefore, variations in distance of the gap between the probe tip and the magnetic recording medium inevitably involved in the information reading/writing operation would disadvantageously make it difficult to ensure signal integrity as represented by a signal-to-noise ratio and a recording error rate.

In the conventional technology as disclosed in IEEE Transactions on Nanotechnology Vol. 1, Issue 1, March 2002, pp 39-55 or U.S. Pat. No. 5,835,477, the medium is supported on a column made of flexible resins for the purpose of ensuring positioning accuracy of the medium actuated by the actuator; therefore, the resinous material of the column functions as a damper when the medium is actuated, which would resultantly lower the resonant frequency, thus making it difficult to increase the data transfer rate. In order to clear up the difficulty, in this example, a multi-probe parallel processing using a large-scale integrated cantilever array structure in which a great number of probe-tipped cantilevers are concentrated in a small area is adopted to increase the data transfer rate. As a result, the cantilever array component has voluminous and complex wiring with lots of diode switches installed, which would cause other problems, such as attenuation of high-frequency signals due to the inter-wire capacitance and a bit loss due to the limited manufacturing yield.

In the conventional technology as disclosed JP 10-40597 A, the recording medium component is supported by a member made of the same material Si as used in the substrate, so that the aforementioned factor affecting the resonant frequency has been removed already; however, there still remains a matter to be addressed therein. To be more specific, it is to be noted that no consideration is given to maintaining a fixed distance of the small gap between the probe tip and the medium. Therefore, changes in the gap may become nonnegligible because of an impact applied to the device or disturbances which may occur depending upon the position/orientation of the device installed in a mobile gear held by a user. Such nonnegligible changes in the gap would disadvantageously become a factor of errors in the information reading/writing operation.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

It is an aspect of the present invention to provide an information processing apparatus for recording information on an information recording medium. To record information on the information recording medium, a probe tip is configured to approach a recordable area allocated on the information recording medium and to effect a local change of state in the recordable area.

In an exemplary embodiment, the information processing apparatus comprises a cantilever array component, a medium component, and a fixed electrode or magnetic pole component, wherein the medium component is disposed between the cantilever array component and the fixed electrode or magnetic pole component. In the cantilever array component, an array of at least one cantilever is installed. The at least one cantilever comprises a probe tip configured as described above. The medium component has a fixed portion and a movable portion, and the information recording medium is installed in the movable portion. The fixed electrode or magnetic pole component is configured to actuate the medium component, i.e., to move the movable portion of the medium component relative to the cantilever array component. The medium component comprises a plurality of first electrodes or magnetic poles that are arranged at three or more spots of the movable portion and configured to support by servo control the information recording medium relative to the array of the at least one cantilever with a gap kept constant between the information recording medium and the array of the at least one cantilever, while allowing the information recording medium to move in two directions X and Y substantially perpendicular to each other, within an X-Y plane substantially parallel to the array of the at least one cantilever. Each of the cantilever array component and the fixed electrode or magnetic pole component comprises a plurality of second electrodes or magnetic poles configured to repel or attract the plurality of first electrode or magnetic poles. The plurality of second electrodes or magnetic poles are significantly different in size in a plane parallel to the X-Y plane from the plurality of first electrodes or magnetic poles.

In another exemplary embodiment, the information processing apparatus comprises a cantilever array component, a medium component, and a fixed electrode or magnetic pole component, wherein the cantilever array component is disposed between the medium component and the fixed electrode or magnetic pole component. The cantilever array component has a fixed portion and a movable portion, and an array of at least one cantilever is installed in the movable portion. The at least one cantilever comprises a probe tip configured as described above. In the medium component, the information recording medium is installed. The fixed electrode or magnetic pole component is configured to actuate the cantilever array component, i.e., to move the movable portion of the cantilever array component relative to the medium component. The cantilever array component comprises a plurality of first electrodes or magnetic poles that are arranged at three or more spots of the movable portion and configured to support the array of the at least one cantilever relative to the information recording medium with a gap kept constant between the array of the at least one cantilever and the information recording medium, while allowing the array of the at least one cantilever to move in two directions X and Y substantially perpendicular to each other, within an X-Y plane substantially parallel to the information recording medium. Each of the medium component and the fixed electrode or magnetic pole component comprises a plurality of second electrodes or magnetic poles configured to repel or attract the plurality of first electrode or magnetic poles. The plurality of second electrodes or magnetic poles in a plane parallel to the X-Y plane are significantly different in size in a plane parallel to the X-Y plane from the first electrodes or magnetic poles.

With the above embodiments, the tendency toward decrease in resonant frequency can be repressed, so that the data transfer rate can be increased. Further, a gap between a probe tip and a medium can be maintained constant at a short distance, and thus the aforementioned factor of errors in the information reading/writing operation as induced by an impact applied to the device or disturbances which may occur depending upon the position/orientation of the device installed in a mobile gear held by a user can be removed effectively.

In the information processing apparatus as implemented according to the above embodiments, the plurality of first electrodes or magnetic poles may comprise electromagnetic coils or permanent magnets having directions of magnetization substantially perpendicular to the X-Y plane, and the plurality of second electrodes or magnetic poles may comprise electromagnetic coils or permanent magnets having directions of magnetization that are the same as or opposite to the directions of magnetization of the plurality of first electrodes or magnetic poles. This is one of the simplest constructions achieved easily by a thin-film forming process without sacrificing the advantages that may be derived from the inventive features of the present embodiments.

Alternatively or additionally, in the information processing apparatus as implemented according to the above embodiments, the plurality of first electrodes or magnetic poles may comprise electromagnetic coils or permanent magnets having directions of magnetization substantially parallel to the X-Y plane, while the directions of magnetization of adjacent first electrodes or magnetic poles are substantially perpendicular to each other in the X-Y plane; and the plurality of second electrodes or magnetic poles may comprise electromagnetic coils or permanent magnets having directions of magnetization that are the same as the directions of magnetization of the plurality of first electrodes or magnetic poles. This construction may be preferable in particular applications because the necessity for installing many electromagnetic coils or the like in the movable portion can be obviated so that the advantages that may be derived from the inventive features of the present embodiments can be obtained without causing the increase in temperature of the movable portion and surrounding components.

The probe storage system configuration as proposed above may be able to achieve the following advantages. Oscillations in direction Z which are likely to occur when an actuator moves the movable portion in directions within X-Y plane can be controlled to the limit not exceeding a permissible level, and thus the bandwidth for servo control can be raised. Accordingly, the decrease in data transfer rate, which would cause significant problems especially in a mass storage system, can be prevented, with the result that a high-speed/quick-response storage device can be provided. Moreover, the distance between the probe tip and the information recording medium can be maintained with high precision, and thus the signal-to-noise ratio in the information reading/writing operation can be improved. Further, even under conditions where an impact applied to the device or disturbances which may occur depending upon the position/orientation of the device installed in a mobile gear held by a user would possibly be received, the recording error rate can be reduced effectively. Consequently, a large-capacity storage device suitable for use in mobile computing devices can be provided.

Other advantages and further features of the present invention will become readily apparent from the following description of exemplary embodiments with reference to accompanying drawings.

### BRIEF DESCRIPTION OF THE DRAWINGS

FIGS. 1A and 1B show a plan view and a sectional view, respectively, for explaining an overall structure of an information processing apparatus using a probe according to a first exemplary embodiment of the present invention.

FIG. 2 shows an exploded perspective view of the information processing apparatus for explaining the structure according to the first exemplary embodiment.

FIG. 3 shows a vertical section of the information processing apparatus for explaining the structure according to the first exemplary embodiment.

FIG. 4A shows a sectional view of an overall structure of the information processing apparatus, and FIGS. 4B and 4C show plan views of its components for explaining an arrangement of each electrode or magnetic pole according to the first exemplary embodiment.

FIGS. 5A and 5B schematically show an example of arrangement (first arrangement) of a set of supporting electrodes or magnetic poles arranged in parallel for use in the information processing apparatus according to the first exemplary embodiment.

FIG. 6 is a schematic illustration showing a moving electrode or magnetic pole and fixed permanent magnets arranged in pair.

FIGS. 7A, 7B and 7C show an overall structure of an information processing apparatus using a probe according to a second exemplary embodiment of the present invention, in which FIG. 7A is a sectional view thereof, and FIGS. 7B and 7C are plan views of its components as disassembled.

FIGS. 8A and 8B schematically show an example of arrangement (second arrangement) of a set of supporting electrodes or magnetic poles arranged in parallel for use in the information processing apparatus according to the second exemplary embodiment.

FIGS. 9A and 9B schematically show an example of arrangement (third arrangement) of a set of supporting electrodes or magnetic poles arranged in parallel for use in the information processing apparatus according to a third exemplary embodiment.

FIGS. 10A, 10B and 10C show an overall structure of an information processing apparatus using a probe according to a fourth exemplary embodiment of the present invention, in which FIG. 10A is a sectional view thereof, and FIGS. 10B and 10C are plan views of its components as disassembled.

FIGS. 11A, 11B and 11C show an overall structure of an information processing apparatus using a probe according to a fifth exemplary embodiment of the present invention, in which FIG. 11A is a sectional view thereof, and FIGS. 11B and 11C are plan views of its components as disassembled.

FIGS. 12A, 12B and 12C show an overall structure of an information processing apparatus using a probe according to a sixth exemplary embodiment of the present invention, in which FIG. 12A is a sectional view thereof, and FIGS. 12B and 12C are plan views of its components as disassembled.

FIGS. 13A, 13B and 13C show examples of actuator supporting spring structures applicable to any of the illustrated exemplary embodiments.

FIGS. 14A, 14B, 14C and 14D are schematic illustrations showing relative positions of a cantilever array and recordable areas of a recording medium applicable to any of the illustrated exemplary embodiments.

FIGS. 15A, 15B and 15C show an example of a recording medium applicable to any of the illustrated exemplary embodiments.

FIG. 16 is an exploded perspective view schematically showing a conventional multi-probe storage device.

### DETAILED DESCRIPTION OF THE EXEMPLARY EMBODIMENTS

A detailed description will be given of the exemplary embodiments of the present invention in comparison with a conventional apparatus, with reference to the accompanying drawings.

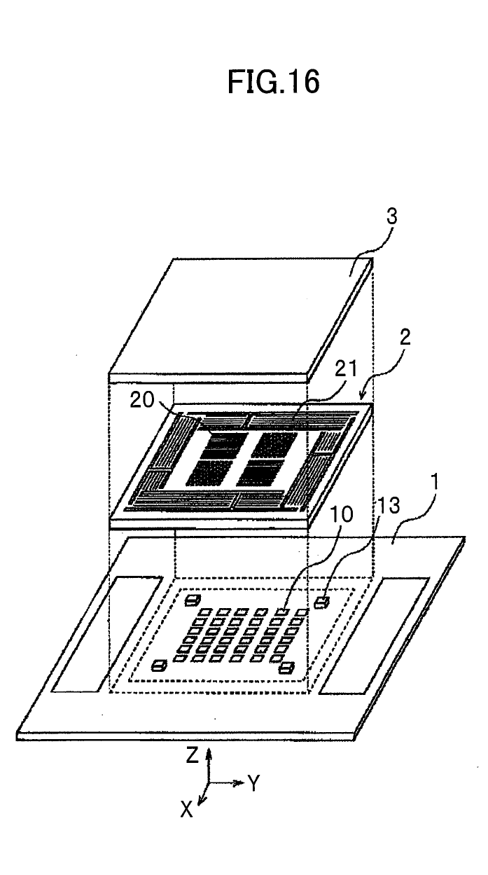

Referring now to FIG. 16, which schematically shows an overall structure of a conventional apparatus, a multi-probe storage device as a conventional example includes a cantilever array component 1 fixed to a rest frame and an information recording medium component 2 (hereinafter referred to simply as “medium component”) arranged substantially parallel to the cantilever array component 1 with a certain distance kept between the cantilever array component 1 and the medium component 2. The cantilever array component 1 has a plurality of probe tips for writing/reading electronic information. To be more specific, the cantilever array component 1 includes a cantilever array 10, a fixed electrode (not shown) and a suction electrode 13. The medium component 2 has a fixed portion fixed to the rest frame, and a movable portion supported to the fixed portion through supporting springs 21. The movable portion of the medium component 2 includes a medium 20 having recordable areas, and a moving electrode arranged near the fixed electrode of the cantilever array component 1.

In this arrangement, when a voltage is applied between the fixed electrode and the moving electrode, an electric field generated by this voltage urges the movable portion of the medium component 2 to move. However, since the supporting springs 21 places a constraint on movement of the movable portion of the medium component 2 in vertical direction (direction Z), the movable portion of the medium component 2 is shifted mostly in horizontal directions (directions X and Y parallel to an X-Y plane) but only slightly in the direction Z. When electronic information is written on the medium 20, a voltage is applied to a selected probe tip, and at the same time a voltage is applied to the suction electrode 13 as well so that the movable portion of the medium component 2 is actuated to move slightly in the direction Z toward the cantilever array 10 of the cantilever array component 1. Thus, the selected probe tip is pushed to the recordable area of the medium 20 provided in the movable portion of the medium component 2, to change dielectric characteristics of a portion of the medium 20 with which the probe tip is brought into contact.

In the illustrated conventional example, as described above, no consideration is given to the necessity of maintaining a small gap between each of the probe tips in array and the medium at a certain distance, and thus there remains the problem that changes in the gap, which may be caused by an impact applied to the device or disturbances which may occur depending upon the position/orientation of the device installed in a mobile gear held by a user, would possibly become a factor of errors in the information reading/writing operation. Moreover, since the movement in directions X and Y (a direction parallel to the plane X-Y) and the suction in the direction Z are not regulated independently, it would disadvantageously be necessary to provide a complicate control system for constantly canceling interference of the two regulations.

### First Exemplary Embodiment

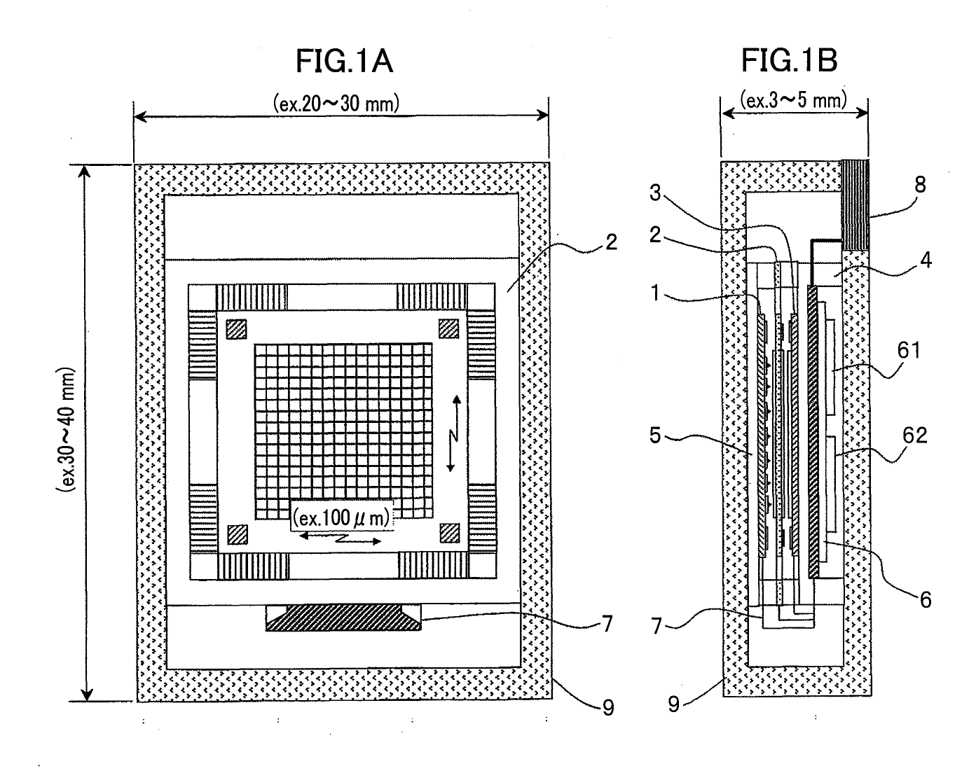

FIGS. 1A and 1B show a plan view and a sectional view, respectively, for explaining an overall structure of an information processing apparatus using a probe according to a first exemplary embodiment of the present invention.

As shown in FIGS. 1A and 1B, the information processing apparatus according to the first exemplary embodiment includes, but not limited thereto, an assembly unit 5, a mount board 6, a stage controller 61, a signal processing circuit 62, a cable sheet 7, a connector 8, and a housing 9 for encasing the other components. The assembly unit 5 includes, but not limited thereto, a cantilever array component 1, a medium component 2, and a fixed electrode or magnetic pole component 3. The assembly unit 5 further includes an electromagnetic actuator (not shown) for actuating a medium 20 installed on the medium component 2. The assembly unit 5 is supported on the housing 9 through a vibration isolation pad 4.

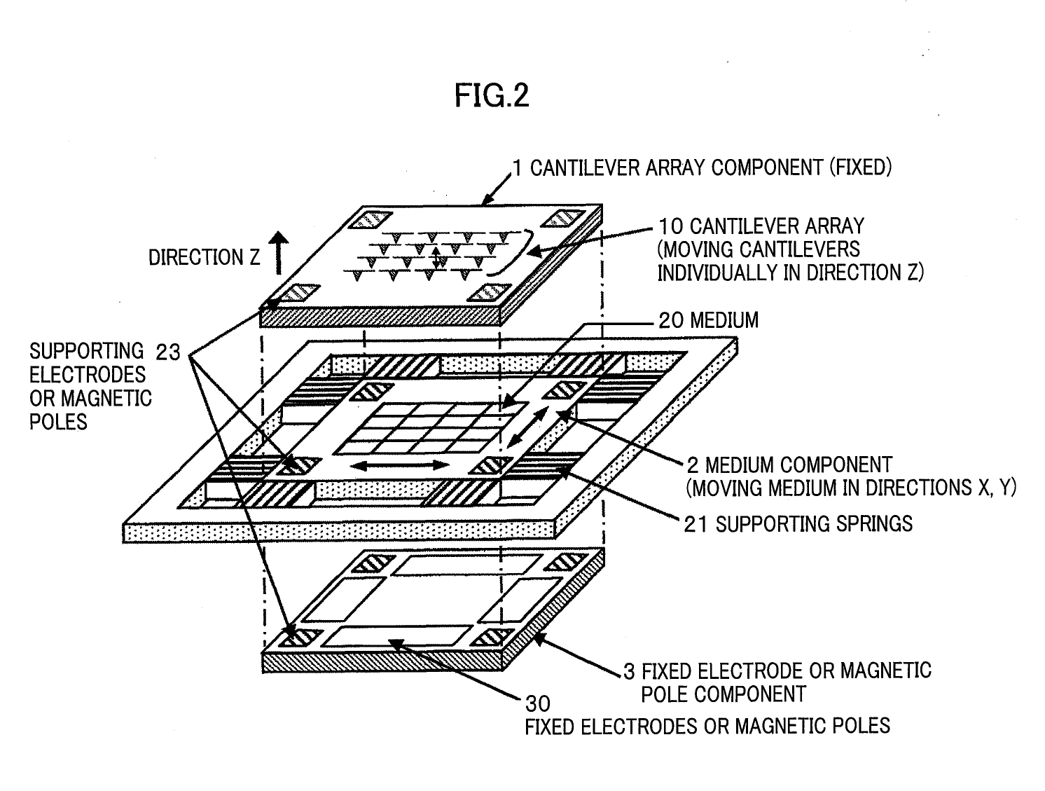

Details of the assembly unit as the first exemplary embodiment of the present invention will now be described with reference to FIGS. 2, 3, 4A, 4B and 4C.

FIG. 2 is an exploded perspective view illustrated for explaining the structure according to the first exemplary embodiment. As shown in FIG. 2, a cantilever array component 1 in which a cantilever array 10 (an array of at least one cantilevers) is installed is fixed to a rest frame, and each cantilever is actuated to independently move in the direction Z, whereas a medium 20 installed in a information recording medium component 2 is actuated by means of a fixed electrode or magnetic pole component 3 to move in directions X and Y parallel to the plane X-Y.

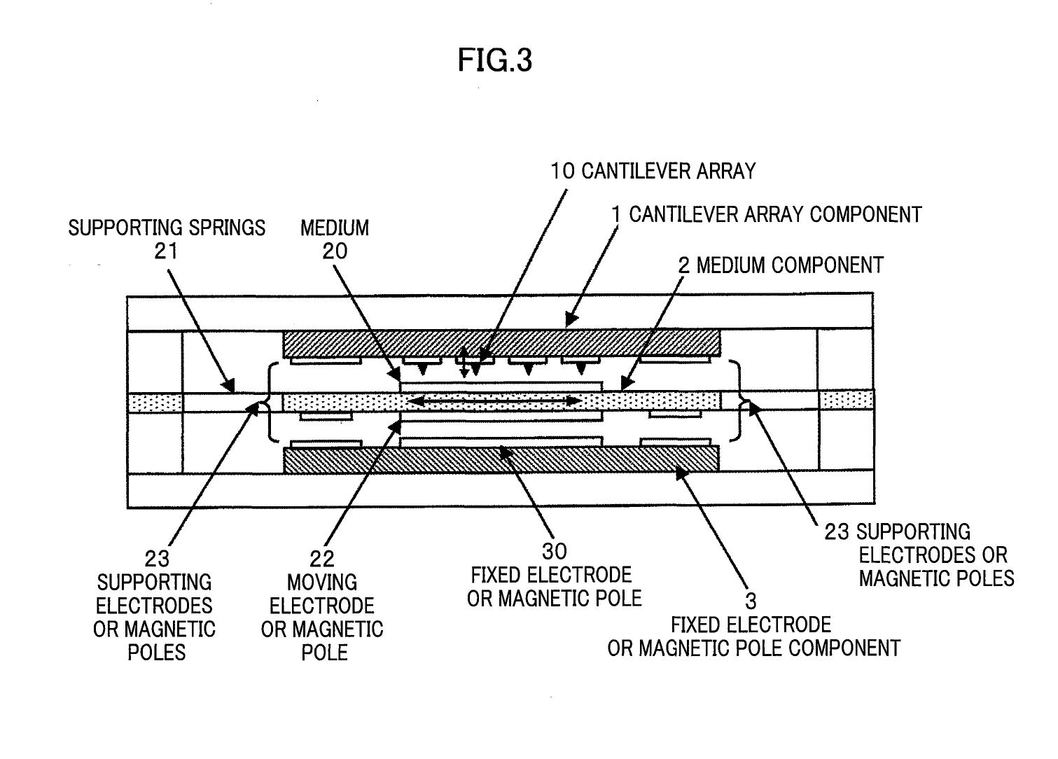

FIG. 3 is a vertical-sectional view illustrated for explaining the structure according to the first exemplary embodiment. As shown in FIG. 3, the cantilever array component 1 includes a cantilever array 10, and the medium component 2 includes a medium 20 installed in a movable portion of the medium component 2 which is supported through supporting springs 21, so that each cantilever is shifted toward the medium 20 independently, and a probe provided at a tip of each cantilever is used to record information on the medium 20. A moving electrode or magnetic pole 22 is provided on a reverse side (opposite to a side on which the medium 20 is provided) of the movable portion of the medium component 2. A fixed electrode or magnetic pole 30 is provided on a fixed electrode or magnetic pole component 3. Action/counteraction between the moving electrode or magnetic pole 22 and the fixed electrode or magnetic pole 30 exerts an actuating force in horizontal directions (directions X and Y or directions parallel to the plane X-Y) on the medium 20, to impart a stroke of motion to the medium 20. Each of these three components 1, 2 and 3 include supporting electrodes or magnetic poles 23 arranged in an optimum manner, and their repelling/attracting forces are controlled appropriately so that the medium 20 is supported stably without shifting in the vertical direction (direction Z) when the medium 20 is actuated to move in the directions X and Y (direction parallel to the plane X-Y).

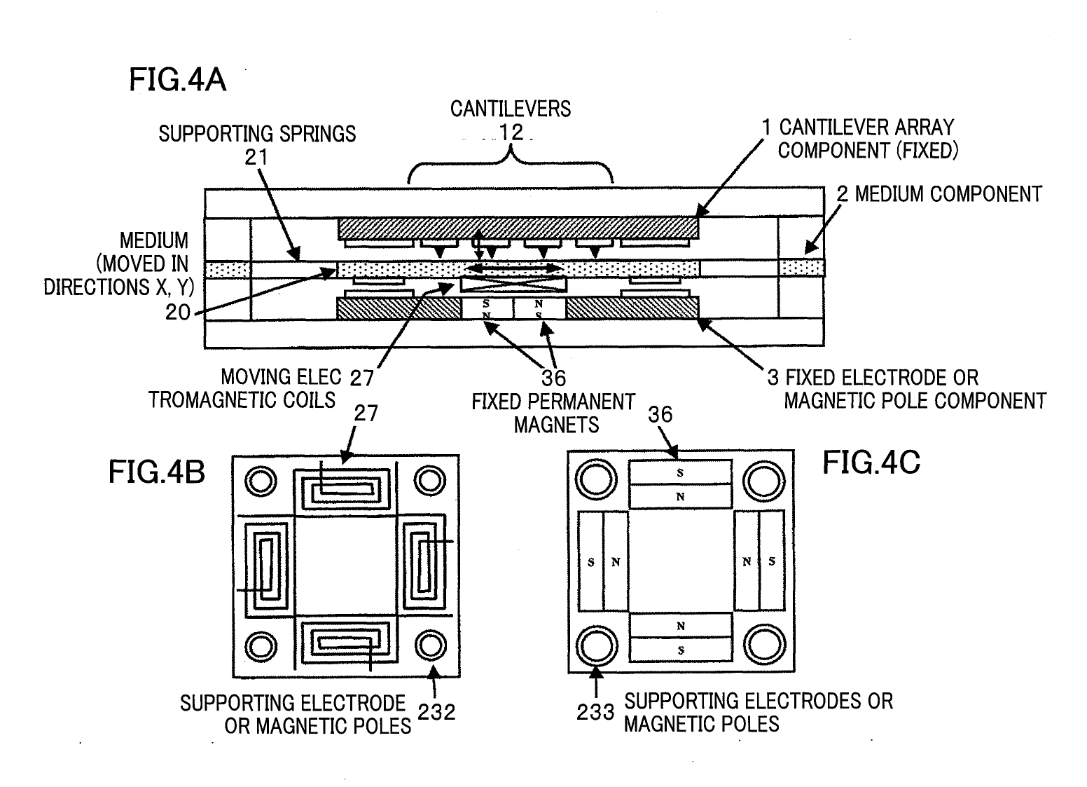

FIG. 4A is a sectional view of an overall structure of the information processing apparatus, and FIGS. 4B and 4C are plan views of its components for explaining an arrangement of each electrode or magnetic pole according to the first exemplary embodiment. In the illustrated embodiment, four moving electromagnetic coils 27 are provided in the medium component 2 as the moving electrodes or magnetic poles of the medium component 2, and four fixed permanent magnets 36 are provided in the fixed electrode or magnetic pole component 3 as the fixed electrodes or magnetic poles. As shown in FIGS. 4A and 4B, in this exemplary embodiment, the moving electromagnetic coils 27 are opposed to the fixed permanent magnets 36, respectively, and the positions of the coils 27 and the magnets 36 corresponding thereto are matched to each other. Four supporting electrodes or magnetic poles 232 are provided in the medium component 2 as shown in FIG. 4B, and four supporting electrodes or magnetic poles 233 are provided in the fixed electrode or magnetic pole component 3 as shown in FIG. 4C, wherein the supporting electrodes or magnetic poles 232 are opposed to the supporting electrodes or magnetic poles 233 corresponding thereto, respectively.

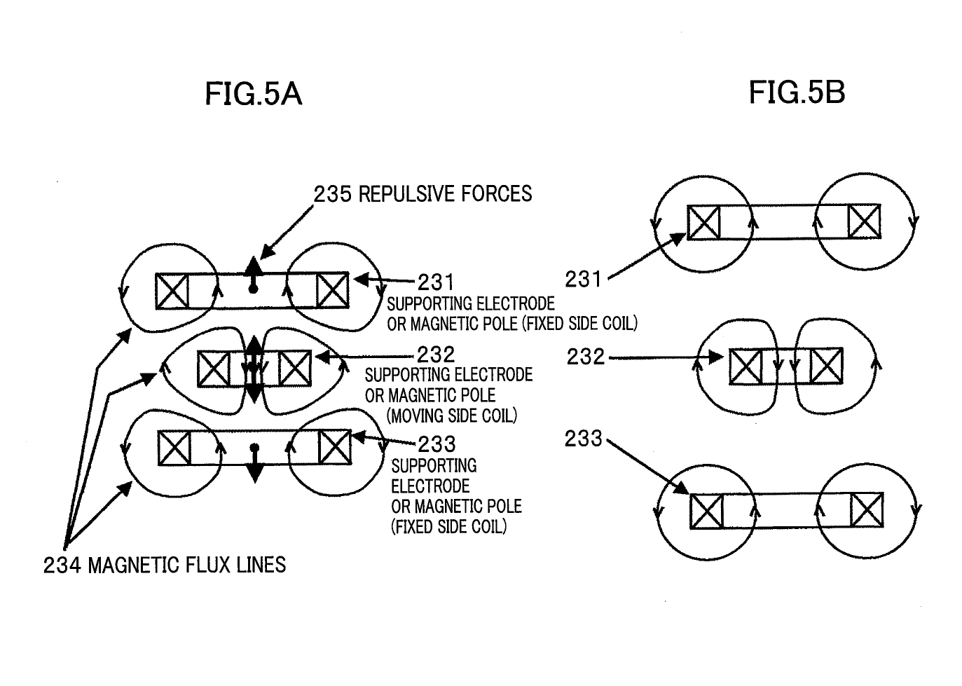

Operation of the supporting electrodes or magnetic poles 23 in the first exemplary embodiment of the present invention will now be described with reference to FIGS. 5A and 5B, which are sections of supporting electrodes or magnetic poles 23 illustrated for explaining relative positions by way of example. FIG. 5A schematically shows actual relative positions of the supporting electrodes or magnetic poles 23. Each supporting electrode or magnetic pole 23 is comprised of an electromagnetic coil capable of generating a magnetic flux as indicated by magnetic flux lines 234 in response to a feed of an electric current. A supporting electrode or magnetic pole 232 installed in a moving component (hereinafter referred to as ‘moving side’ supporting electrode of magnetic pole 232) is arranged between supporting electrodes or magnetic poles 231 and 233 each installed in a fixed component (hereinafter referred to as ‘fixed side’ supporting electrodes or magnetic poles 231 and 233). The moving side supporting electrode or magnetic pole 232 in this example is a coil designed to have a smaller diameter so that the moving side supporting electrode or magnetic pole 232 is significantly different in size in a plane parallel to the X-Y plane from the other two electrodes or magnetic poles 231 and 233. The magnetic flux lines 234 have respective shapes like a vertically symmetric loop when the coils 231, 232 and 233 are distanced sufficiently from each other, as shown in FIG. 5B. On the other hand, if the directions of electric currents passed through the coils are set such that electromagnetic fields induced by the opposed coils make them mutually repulsive, the coils 231, 232 and 233, when brought sufficiently closer together, repel each other and produce repulsive forces as shown in FIG. 5A. As a result, the moving side supporting electrode or magnetic pole 232 sandwiched between the other two electrodes or magnetic poles 231 and 233 are acted on by opposing electromagnetic forces, and a proper balance can be attained when the moving side supporting electrode or magnetic pole 232 comes to a position in which the electromagnetic forces become equal. In this embodiment, since the moving side supporting electrode or magnetic pole 232 is comprised of a coil having a diameter smaller than those of the other two electrodes or magnetic poles 231 and 233, the electromagnetic forces also serve to restrict displacement of the moving side supporting electrode or magnetic pole 232 in directions X and Y (direction parallel to the plane X-Y). A set of such moving electrodes or magnetic poles 231, 232 and 233 may be installed in three or more spots on respective components 1, 2 and 3, so that a surface position of the moving component can be supported in a desired vertical position by regulating an electric current passed through each coil.

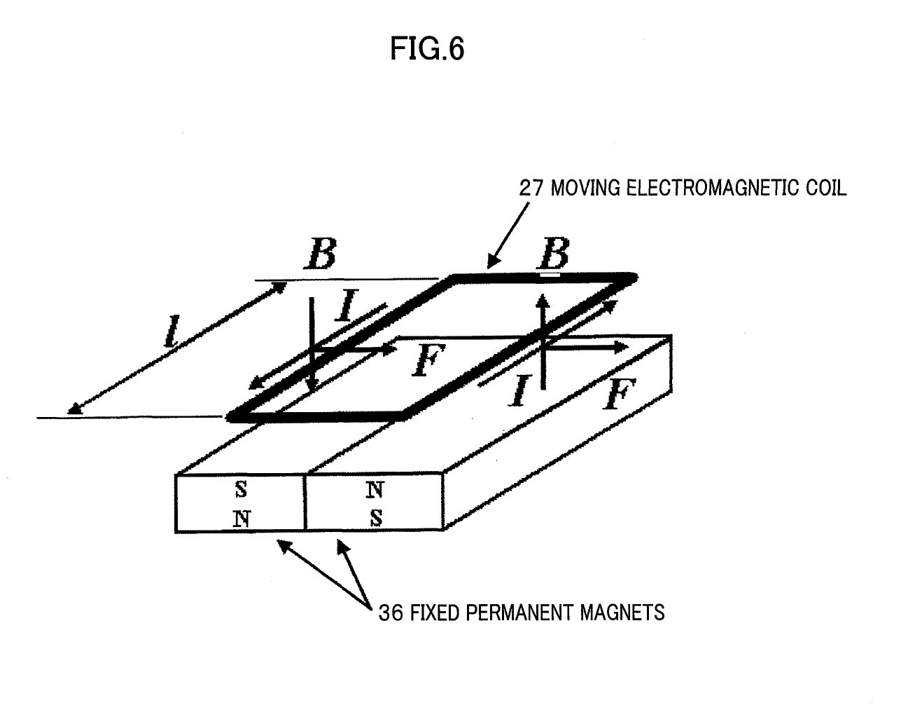

Next, the principle on which the moving electromagnetic coil 27 and the fixed permanent magnet 36 produce an actuating force in directions X, Y (direction parallel to the plane X-Y) according to the first exemplary embodiment of the present invention will be described with reference to FIG. 6. FIG. 6 schematically shows a pair of electrodes or magnetic poles on which electromagnetic forces are acted. If an electric current is passed through a coil installed within a magnetic field produced by the fixed permanent magnets 36, a Lorentz force F operates on the coil in a direction of the vector product of an electric current element vector I and a magnetic flux density vector B (under the Fleming's left-hand rule in such a manner as may be explained by the Biot-Savart law). In the first exemplary embodiment, since the arrangement of electrodes or magnetic poles as shown in FIG. 6 is adopted, the Lorentz forces acting respectively on the longer electric current elements (in a direction perpendicular to the longer sides) of the moving electromagnetic coil 27 are superposed, and thus the actuating force is produced efficiently.

### Second Exemplary Embodiment

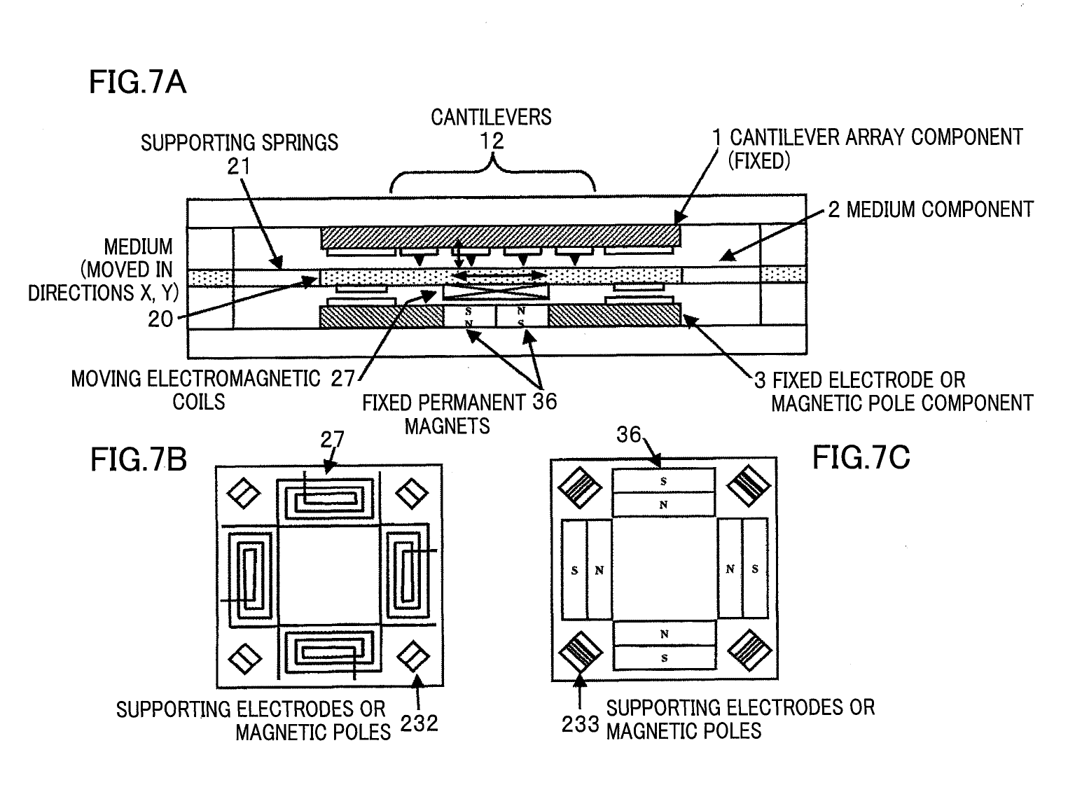

FIG. 7A is a sectional view of an overall structure of an alternative information processing apparatus using a probe according to a second exemplary embodiment of the present invention, and FIGS. 7B and 7C are plan views of its components for explaining an arrangement of each electrode or magnetic pole provided in the second exemplary embodiment.

Supporting electrodes or magnetic poles 232, 233 located at four corners of the movable portion of the medium component 2 and the fixed electrode or magnetic pole component 3, respectively, produce repulsive forces between opposed electrodes or magnetic poles 232 and 233, and serve to support the medium 20 suspended in balance so that the medium 20 may not wobble in the direction Z. The four moving side supporting electrodes or magnetic poles 232 are maintained at the same potential (preferably including the ground potential, but not limited thereto), while the four fixed side supporting electrodes or magnetic poles 233 are maintained at individual potentials, respectively, and a detector for measuring a counter electromotive force at each position is connected to each supporting electrode or magnetic pole 233. In this condition, the electric current applied to the fixed side supporting electrodes or magnetic poles 233 are regulated by servo control so that a deviation in the counter electromotive force is minimized which would otherwise appear due to slight wobbling in direction Z accompanied with an operation of the actuator moving the medium 20 in directions X and Y (direction parallel to the plane X-Y).

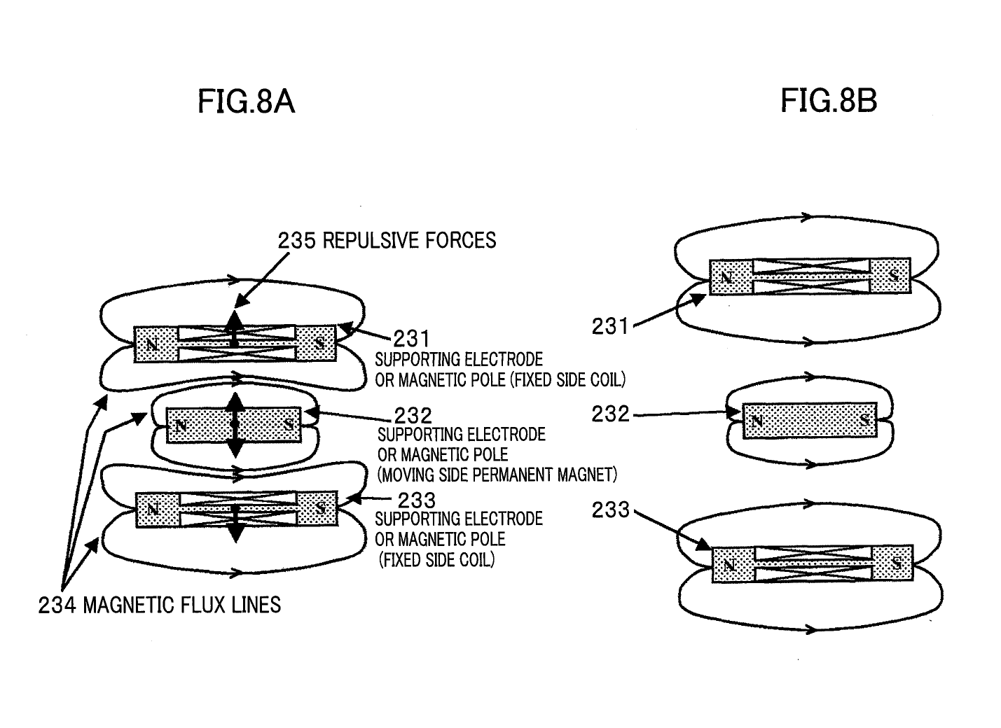

FIGS. 8A and 8B show an example of arrangement of a set of supporting electrodes or magnetic poles arranged in parallel for use in the information processing apparatus according to the second exemplary embodiment of the present invention. The supporting electrodes or magnetic poles 231, 232 and 233 are arranged with their polarities oriented in one and the same direction. The moving side permanent magnet 232 is sandwiched between the fixed side electromagnetic coils 231 and 232. In addition, as shown in FIGS. 7B and 7C, the directions of magnetization of adjacent supporting electrodes or magnetic poles are substantially perpendicular to each other on the respective components 2 and 3. This arrangement allows the medium 20 to be supported stably without shifting vertically (in direction Z) when the medium 20 is actuated in directions X and Y (direction parallel to the plane X-Y).

The moving side supporting electrode or magnetic pole 232 is designed to be smaller than the fixed side supporting electrode or magnetic pole 233 so that overlapping areas of opposite faces of the fixed side and moving side supporting electrodes or magnetic poles will not change even if the positions of the moving side supporting electrode or magnetic poles are shifted in directions X and Y (direction parallel to the plane X-Y) when the medium 20 is moved in directions X and Y. This setup serves to prevent variations in the electromagnetic force which would be caused by actuation of the medium 20 in directions X and Y, and therefore enables mutually independent control over movement of directions X and Y and support in direction Z.

In the actuator according to the second exemplary embodiment, the balance in direction Z is maintained by servo control, and constraint with damper action as adopted in the column made of resinous material in the conventional example is not applied; therefore, a high resonant frequency can be maintained when the medium is actuated in directions X and Y, and fast actuation becomes possible as a result. Further, the medium is supported in such a manner as to reduce wobbling in direction Z, and thus the gap between the probe tip and the medium can be kept constant at a certain distance, which increases the recording density and the signal-to-noise ratio, to thereby make the recording error rate lower.

### Third Exemplary Embodiment

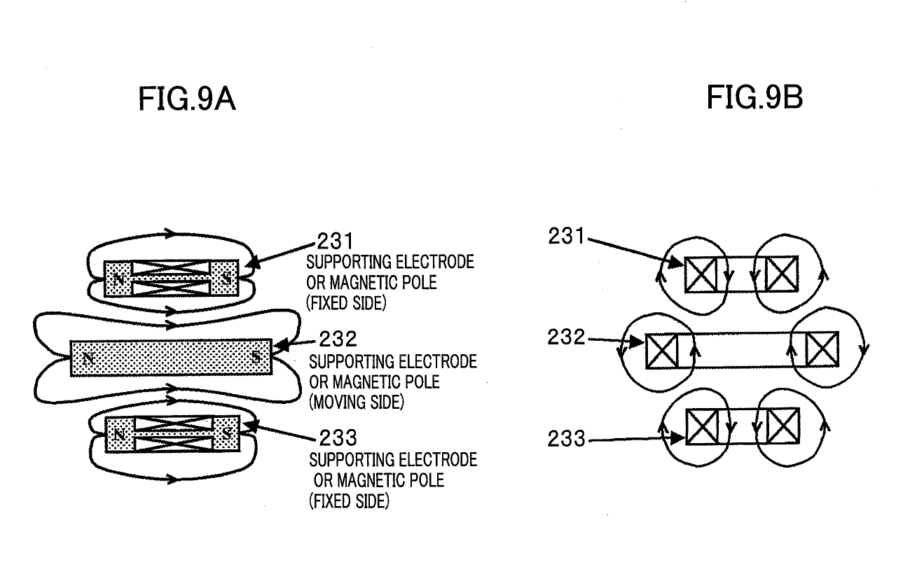

FIGS. 9A and 9B show an example of arrangement (third arrangement) of a set of supporting electrodes or magnetic poles arranged in parallel for use in an alternative information processing apparatus according to a third exemplary embodiment. Unlike the embodiments as described above in which the moving side supporting electrode or magnetic pole is designed to be smaller than the fixed side supporting electrode or magnetic pole, the third exemplary embodiment proposes a contrary arrangement, in which the moving side supporting electrode or magnetic pole 232 is larger than the fixed side supporting electrodes or magnetic poles 231, 233. This alternative arrangement can also achieve the same balance and support control.

### Fourth Exemplary Embodiment

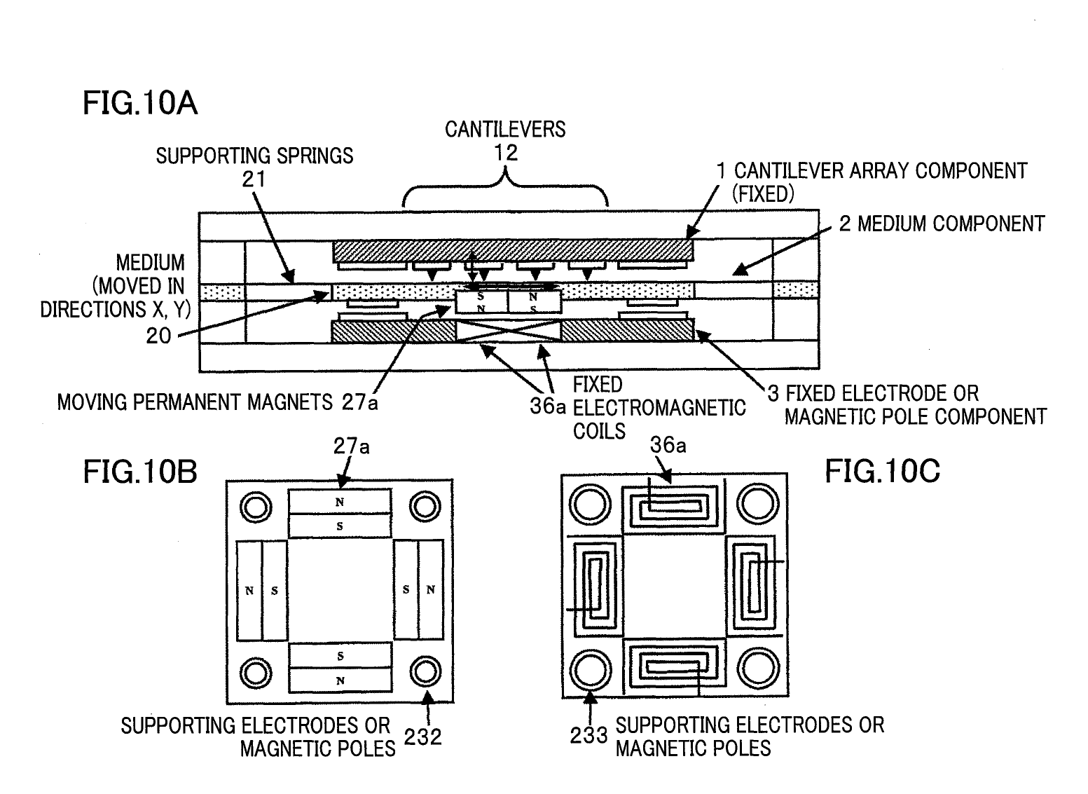

An overall structure of an alternative information processing apparatus using a probe according to a fourth exemplary embodiment of the present invention is shown in FIGS. 10A, 10B and 10C, in which FIG. 10A is a sectional view thereof, and FIGS. 10B and 10C are plan views of its components as disassembled. In this embodiment, the arrangement of the moving and fixed electrodes or magnetic poles which is designed to cause a stroke of movement in directions X and Y is different from that of the first exemplary embodiment, and permanent magnets 27a are arranged in the moving side component (2), while electromagnetic coils 36a are arranged in the fixed side component (3). This arrangement also enables actuation of the moving side component by the Lorentz forces similar to those as described above. In this embodiment, particularly, the number of coils installed in the moving side component may be reduced, to thereby reduce the total amount of electric current required for actuation, so that heat generation of the moving side component can be reduced advantageously.

### Fifth Exemplary Embodiment

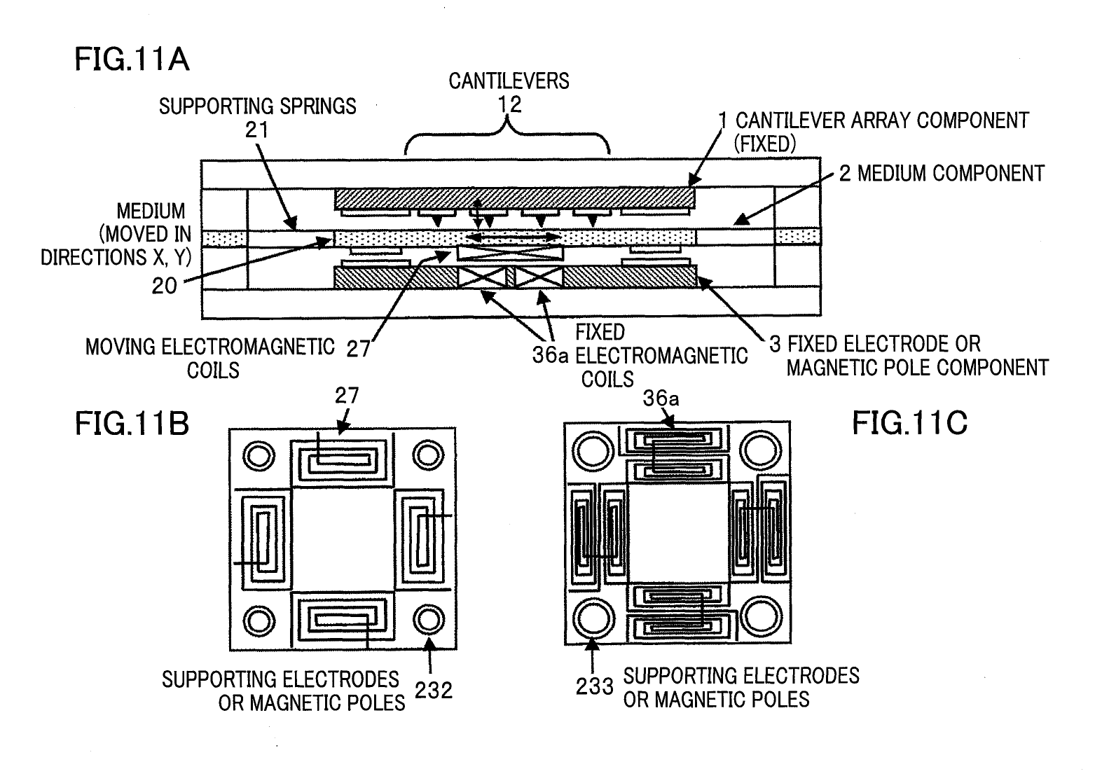

An example of arrangement of an alternative information processing apparatus using a probe according to a fifth exemplary embodiment of the present invention is shown in FIGS. 11A, 11B and 11C, in which FIG. 11A is a sectional view thereof, and FIGS. 11B and 11C are plan views of its components as disassembled. In this embodiment, the arrangement of the moving and fixed electrodes or magnetic poles which is designed to cause a stroke of movement in directions X and Y is different from those of the first and fourth exemplary embodiments, and electromagnetic coils 27 are arranged in the moving side component (2), while electromagnetic coils 36a are arranged in the fixed side component (3). This arrangement also enables actuation of the moving side component by the Lorentz forces similar to those as described above.

### Sixth Exemplary Embodiment

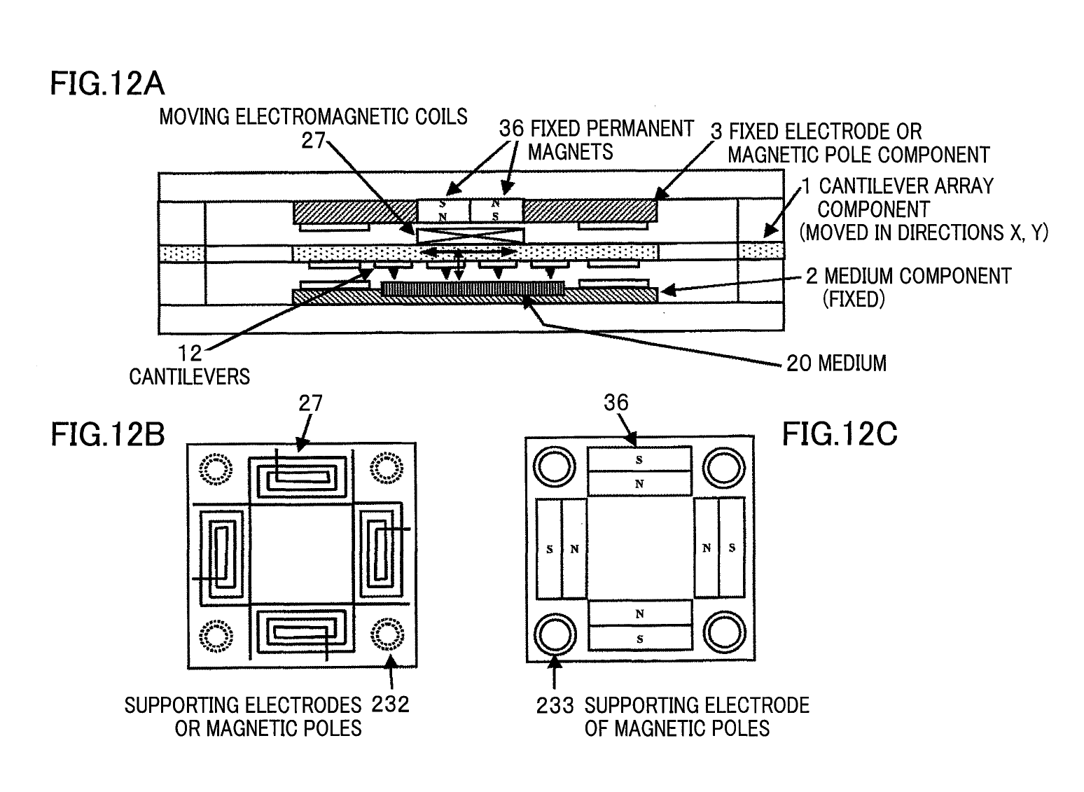

An example of arrangement of an alternative information processing apparatus using a probe according to a sixth embodiment of the present invention is shown in FIGS. 12A, 12B and 12C, in which FIG. 12A is a sectional view thereof, and FIGS. 12B and 12C are plan views of its components as disassembled. This embodiment differs in its overall structure from the aforementioned embodiments, and propose an alternative arrangement in which a cantilever array component 1 provided as a moving side component and a medium component 2 provided as a fixed side component are arranged as illustrated in FIG. 11A. Electromagnetic coils 27 are arranged in the moving side component (1), while fixed permanent magnets 36 are arranged in the fixed side component (2), to thereby actuate the cantilever array component 1 in directions X and Y. This embodiment may add a new advantage to the versatility of the present invention. Specifically, in this embodiment, since the medium 20 is provided as the fixed side component, a storage device having the same construction as that of a medium-exchangeable optical disc drive can be designed with advantageous features incorporated therein.

### Seventh Exemplary Embodiment

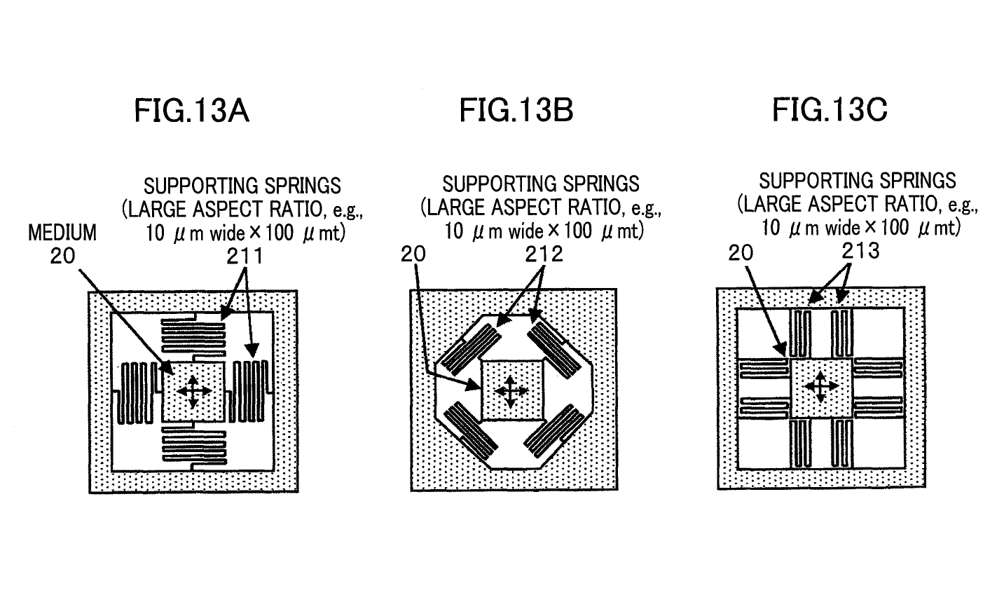

Some examples of actuator supporting spring structures applicable to any of the illustrated exemplary embodiments are taken up for discussion with reference to FIGS. 13A, 13B and 13C. The medium 20 (i.e., the movable portion of the medium component 2 in which the medium 20 is installed) is supported through supporting springs 21 and movable relative to the rest frame in directions X and Y.

Supporting springs 211 as shown in FIG. 13A are comprised of four springs each shaped like the so-called “meander beam” having a folded structure. The supporting springs 211 are connected to end faces of the movable portion of the medium component 2 corresponding to the four sides of the rectangular medium 20. In this example, the supporting spring structure can be installed with reduced spatial gaps, and thus small-sized springs having a sufficiently low spring constant can be provided. Accordingly, a larger amount of shift can be achieved with a smaller actuating force in directions X and Y.

Supporting springs 212 as shown in FIG. 13B are comprised of four supporting springs connected to corner faces of the movable portion of the medium component 2 corresponding to the four vertices of the rectangular medium 20. In this example, the buckle fold or deformation (stress for causing elastica) of the four supporting springs are effected equally in analogous way on every occasion regardless of whether or not the medium 20 is moved in direction X or in direction Y. Accordingly, setting (designing) the spring constant can be made with increased ease. Further, the supporting spring structure can be installed with reduced spatial gaps, and thus small-sized springs having a sufficiently low spring constant can be provided.

Supporting springs 213 as shown in FIG. 13C are comprised of four sets of supporting springs wherein the sets of supporting springs are connected to end faces of the movable portion of the medium component 2 corresponding to the four sides of the rectangular medium 20, respectively. In this example, many routes for connecting the medium 20 to the rest frame are provided. Accordingly, many independent magnetic coils can be arranged in the movable portion of the medium component 2 in which the medium 20 is installed. As a result, the degree of flexibility in controlling the actuation of the medium 20 in directions X and Y can be increased.

In any of the above structures, a large aspect ratio structure (see examples of dimensions indicated in the drawing figures) may preferably but not necessarily be adopted such that the beam thickness relative to the beam width is large enough, because the larger aspect ratio of the supporting springs would reduce wobbling of the medium 20 in direction Z.

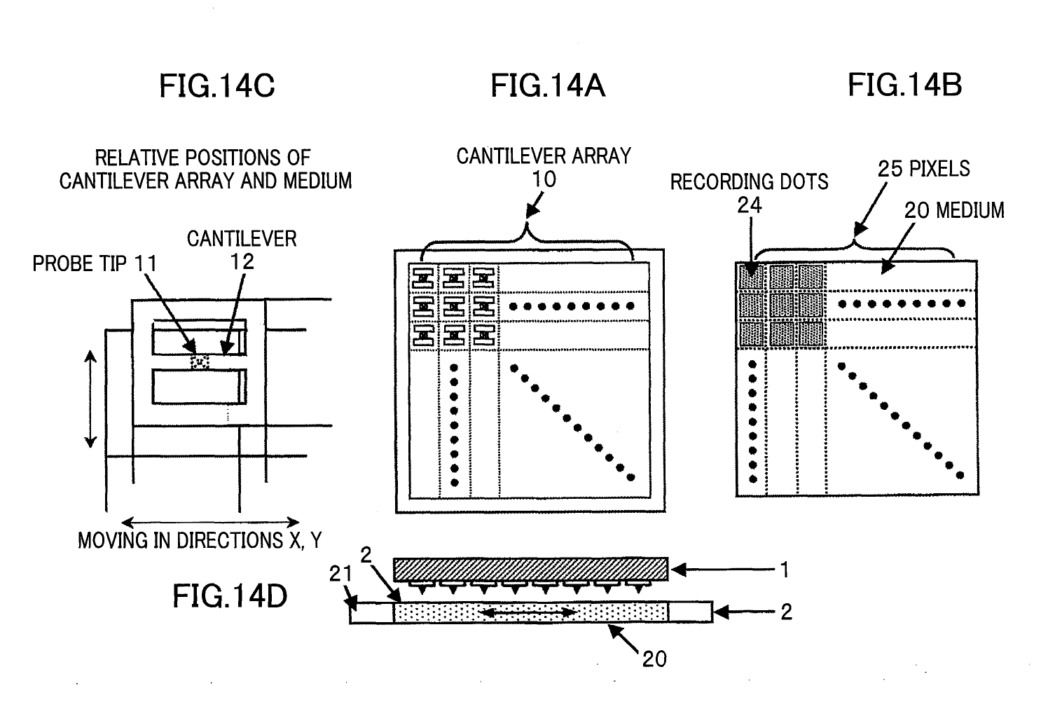

Relative positional relationships between the cantilever array 10 and recordable areas (pixels) 25 allocated in the medium 20, which are applicable to any of the above exemplary embodiments, are illustrated in FIGS. 14A, 14B, 14C and 14D.

FIG. 14A is a plan view schematically showing the cantilever array 10. FIG. 14B is a plan view schematically showing the medium 20. FIG. 14C is a plan view showing relative positions of the cantilever array 10 and the medium 20. FIG. 14D is a cross-sectional view showing relative positions of the cantilever array component 1 and the medium component 2.

As shown in FIG. 14A, the cantilever array 10 comprises an array of cantilevers 12 arranged in directions X and Y. As shown in FIG. 14B, a plurality of recordable areas 25 containing an information recording magnetic material are allocated on the entire surface of the medium 20 and arranged in directions X and Y. As shown in FIGS. 14C and 14D, the cantilever array 10 and the medium 20 are opposed to each other, and a probe tip 11 provided in each cantilever 12 is configured to approach recording dots 24 on the medium 20 to write and read information. Each probe tip 11 is responsible for a recordable area 25 corresponding to a range of stroke of the X-Y actuator. One probe tip 11 comes in a position corresponding to one recording dot 24 in the recordable area 25 on the medium 20, so as to perform an information recording operation. An information recording instruction is transmitted independently to each probe tip 11 on an as-needed basis, so that parallel processing enables a high-speed data transfer.

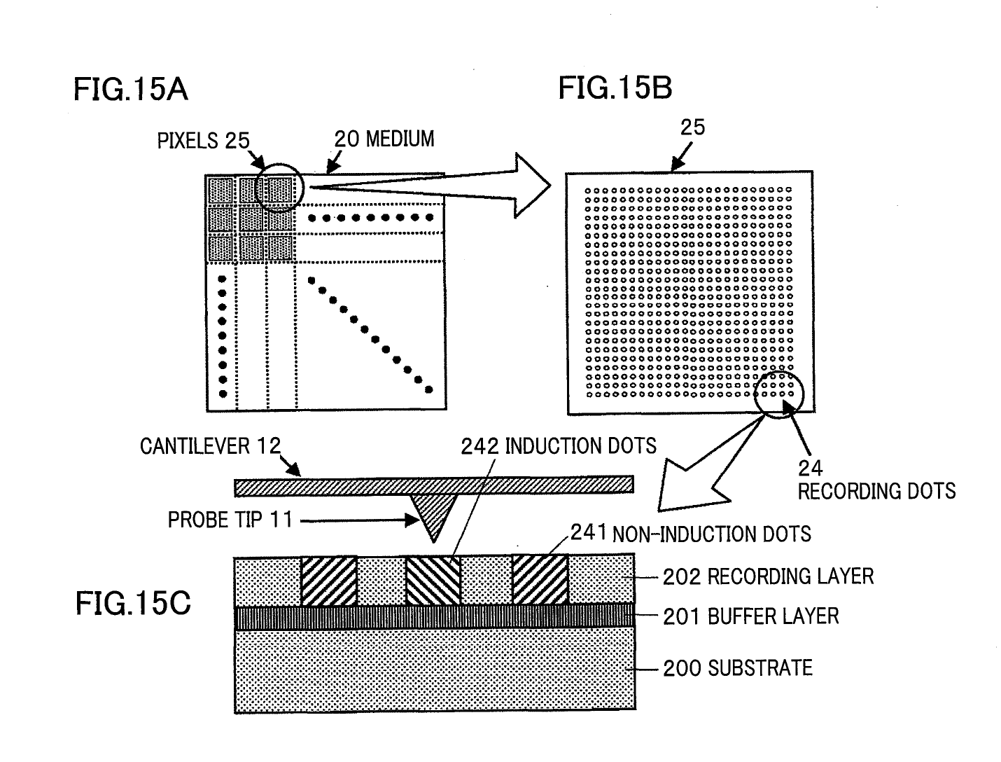

The next discussion focuses on details of a recording medium 20 taken by way of example, which may be applicable to any of the illustrated exemplary embodiments. An example of the recording medium 20 is illustrated in FIGS. 15A, 15B and 15C. FIG. 15A is a schematic plan view of the medium 20. FIG. 15B is a schematic plan view of a recordable area (pixel) 25 in the medium 20 shown in FIG. 15A. FIG. 15C is a schematic cross-sectional view of recording dots 24 in the area 25 shown in FIG. 15B.

As shown in FIGS. 15A and 15B, recording dots 24 are arranged with a few nm to a few tens of nm (e.g., 25 nm) pitch in a certain recordable area 25 on the medium 20. Each recording dot 24 comprises, as shown in FIG. 15C, a recording layer 202 divided into portions different in state from each other, i.e., non-induction dot 241 and induction dot 242, which difference in the state is effected locally in the recording layer 202 by an action of the probe tip 11. In an information recording operation, a voltage is applied to the probe tip 11 that has approached a position several nm above the recording dot 24, to reversibly change the atomic state of the recording layer 202 due to the effect of electric field or the tunnel current caused by the potential difference between the probe tip 11 and the recording dot 24. The change in state of the recording dot (local change of state in the recordable area) makes it possible to write and read information.

According to the exemplified embodiments as described above, the probe tip 11 is controlled so as not to come in contact with the surface of the recording dot 24, and thus no mechanical abrasion would occur. Therefore, the apparatus consistent with the present invention with the long-life information recording medium and cantilever array incorporated therein can be used for a long time.

The information processing apparatus using a probe according to the illustrated exemplified embodiments of the present invention can furnish a solution to a conventional problem of reduced data transfer rate which is critical in mass storage systems, and can provide a high-speed/quick-response storage device. Moreover, the dimensions of the positioning mechanism can be reduced, and the storage device can be downsized in its entirety. Further, irrespective of impacts or disturbances which would become a significant problem in the use of the mobile/portable devices, the signal-to-noise ratio can be maintained during a writing/reading operation. Consequently, a mass storage device with which the recording error rate is reduced effectively can be provided.

According to the present invention, a storage device or memory unit that is packed in a volume smaller than a magnetic disc drive and capable of storing a large volume of data, achieving a recording capacity larger than the existing flash memory can be provided. Since the storage device implemented according to the present invention can realize recording of extremely large volume of information in a small volume equivalent to the flash memory, it is suitable for applications to microminiature mobile information processing terminals such as a video camera, a notebook personal computer, personal digital assistant and a cellular phone. Further, due to its fast operation speed, the information processing device consistent with the present invention may find application in external storage devices for a server that requires large-scale storage as a preferred embodiment of the present invention, and is expected to replace magnetic disc drives.

It is contemplated that numerous modifications may be made to the exemplary embodiments of the invention without departing from the spirit and scope of the embodiments of the present invention as defined in the following claims.

What is claimed is:

1. An information processing apparatus for recording information on an information recording medium, comprising:
a cantilever array component in which an array of at least one cantilever is installed, wherein the at least one cantilever comprises a probe tip configured to approach a recordable area allocated on the information recording medium and to effect a local change of state in the recordable area;
a medium component having a fixed portion and a movable portion, wherein the information recording medium is installed in the movable portion; and
a fixed electrode or magnetic pole component for moving the movable portion of the medium component relative to the cantilever array component,
wherein the medium component comprises a plurality of first electrodes or magnetic poles arranged at three or more spots of the movable portion and configured to support by servo control the information recording medium relative to the array of the at least one cantilever with a gap kept constant between the information recording medium and the array of the at least one cantilever, while allowing the information recording medium to move in two directions X and Y substantially perpendicular to each other, within an X-Y plane substantially parallel to the array of the at least one cantilever,
wherein each of the cantilever array component and the fixed electrode or magnetic pole component comprises a plurality of second electrodes or magnetic poles configured to repel or attract the plurality of first electrode or magnetic poles, the plurality of second electrodes or magnetic poles being significantly different in size in a plane parallel to the X-Y plane from the plurality of first electrodes or magnetic poles, and
wherein the medium component is disposed between the cantilever array component and the fixed electrode or magnetic pole component.

2. An information processing apparatus for recording information on an information recording medium, comprising:
a cantilever array component having a fixed portion and a movable portion, wherein an array of at least one cantilever is installed in the movable portion, wherein the at least one cantilever comprises a probe tip configured to approach a recordable area allocated on the information recording medium and to effect a local change of state in the recordable area;
a medium component in which the information recording medium is installed; and
a fixed electrode or magnetic pole component for moving the movable portion of the cantilever array component relative to the medium component,
wherein the cantilever array component comprises a plurality of first electrodes or magnetic poles arranged at three or more spots of the movable portion and configured to support the array of the at least one cantilever relative to the information recording medium with a gap kept constant between the array of the at least one cantilever and the information recording medium, while allowing the array of the at least one cantilever to move in two directions X and Y substantially perpendicular to each other, within an X-Y plane substantially parallel to the information recording medium,
wherein each of the medium component and the fixed electrode or magnetic pole component comprises a plurality of second electrodes or magnetic poles configured to repel or attract the plurality of first electrode or magnetic poles, the plurality of second electrodes or magnetic poles being significantly different in size in a plane parallel to the X-Y plane from the plurality of first electrodes or magnetic poles; and
wherein the cantilever array component is disposed between the medium component and the fixed electrode or magnetic pole component.

3. An information processing apparatus according to claim 1, wherein the plurality of first electrodes or magnetic poles comprise electromagnetic coils or permanent magnets having directions of magnetization substantially perpendicular to the X-Y plane; and
wherein the plurality of second electrodes or magnetic poles comprise electromagnetic coils or permanent magnets having directions of magnetization that are the same as or opposite to the directions of magnetization of the plurality of first electrodes or magnetic poles.

4. An information processing apparatus according to claim 2, wherein the plurality of first electrodes or magnetic poles comprise electromagnetic coils or permanent magnets having directions of magnetization substantially perpendicular to the X-Y plane; and
wherein the plurality of second electrodes or magnetic poles comprise electromagnetic coils or permanent magnets having directions of magnetization that are the same as or opposite to the directions of magnetization of the plurality of first electrodes or magnetic poles.

5. An information processing apparatus according to claim 1, wherein the plurality of first electrodes or magnetic poles comprise electromagnetic coils or permanent magnets having directions of magnetization substantially parallel to the X-Y plane, and the directions of magnetization of adjacent first electrodes or magnetic poles are substantially perpendicular to each other in the X-Y plane; and
wherein the plurality of second electrodes or magnetic poles comprise electromagnetic coils or permanent magnets having directions of magnetization that are the same as the directions of magnetization of the plurality of first electrodes or magnetic poles.

6. An information processing apparatus according to claim 2, wherein the plurality of first electrodes or magnetic poles comprise electromagnetic coils or permanent magnets having directions of magnetization substantially parallel to the X-Y plane, and the directions of magnetization of adjacent first electrodes or magnetic poles are substantially perpendicular to each other in the X-Y plane; and
wherein the plurality of second electrodes or magnetic poles comprise electromagnetic coils or permanent magnets having directions of magnetization that are the same as the directions of magnetization of the plurality of first electrodes or magnetic poles.

7. An information processing apparatus for recording information on an information recording medium, comprising:
a cantilever array component in which an array of at least one cantilever is installed, wherein the at least one cantilever comprises a probe tip configured to approach a recordable area allocated on the information recording medium and to effect a local change of state in the recordable area;
a medium component having a fixed portion and a movable portion, wherein the information recording medium is installed in the movable portion; and
a fixed electrode or magnetic pole component for moving the movable portion of the medium component relative to the cantilever array component,
wherein the medium component is disposed between the cantilever array component and the fixed electrode or magnetic pole component,
wherein the medium component comprises three or more first electrodes or magnetic poles that are arranged two-dimensionally in the movable portion;
wherein each of the cantilever array component and the fixed electrode or magnetic pole component comprises second electrodes or magnetic poles that are arranged in positions corresponding to the first electrodes or magnetic poles, and configured to repel or attract the first electrode or magnetic poles; and
wherein the first electrodes or magnetic poles and the second electrodes or magnetic poles corresponding thereto are different in size in directions parallel to a plane on which the first electrodes or magnetic poles are arranged two-dimensionally.

8. An information processing apparatus for recording information on an information recording medium, comprising:
a cantilever array component having a fixed portion and a movable portion, wherein an array of at least one cantilever is installed in the movable portion, wherein the at least one cantilever comprises a probe tip configured to approach a recordable area allocated on the information recording medium and to effect a local change of state in the recordable area;
a medium component in which the information recording medium is installed; and
a fixed electrode or magnetic pole component for moving the movable portion of the cantilever array component relative to the medium component,
wherein the cantilever array component is disposed between the medium component and the fixed electrode or magnetic pole component,
wherein the cantilever array component comprises three or more first electrodes or magnetic poles that are arranged two-dimensionally in the movable portion;
wherein each of the medium component and the fixed electrode or magnetic pole component comprises second electrodes or magnetic poles that are arranged in positions corresponding to the first electrodes or magnetic poles, and configured to repel or attract the first electrode or magnetic poles; and
wherein the first electrodes or magnetic poles and the second electrodes or magnetic poles corresponding thereto are different in size in directions parallel to a plane on which the first electrodes or magnetic poles are arranged two-dimensionally.

9. An information processing apparatus according to claim 7, wherein the first electrodes or magnetic poles are smaller in size in directions parallel to the plane on which the first electrodes or magnetic poles are arranged two-dimensionally than the second electrodes or magnetic poles.

10. An information processing apparatus according to claim 8, wherein the first electrodes or magnetic poles are smaller in size in directions parallel to the plane on which the first electrodes or magnetic poles are arranged two-dimensionally than the second electrodes or magnetic poles.

11. An information processing apparatus according to claim 7, wherein the first electrodes or magnetic poles are larger in size in directions parallel to the plane on which the first electrodes or magnetic poles are arranged two-dimensionally than the second electrodes or magnetic poles.

12. An information processing apparatus according to claim 8, wherein the first electrodes or magnetic poles are larger in size in directions parallel to the plane on which the first electrodes or magnetic poles are arranged two-dimensionally than the second electrodes or magnetic poles.
